(19) United States
(12) Patent Application Publication
(10) Pub. No.: US 2017/0055236 A1
(43) Pub. Date: Feb. 23, 2017

(54) MULTIPLE ACCESS POINT WIRELESS MESH NETWORK

(71) Applicant: LINEAR TECHNOLOGY CORPORATION, Milpitas, CA (US)

(72) Inventors: Alain Pierre LEVESQUE, Pleasanton, CA (US); Lance Robert DOHERTY, San Leandro, CA (US); Jonathan Noah SIMON, Castro Valley, CA (US); William Alan LINDSAY, El Cerrito, CA (US)

(21) Appl. No.: 15/243,335

(22) Filed: Aug. 22, 2016

Related U.S. Application Data
(60) Provisional application No. 62/208,196, filed on Aug. 21, 2015.

(51) Int. Cl. H04W 56/00; H04L 12/26

(52) U.S. Cl. CPC H04W 56/0015; H04L 43/0817; H04W 84/18

(57) ABSTRACT

A mesh network system includes a plurality of network nodes, a network manager, and at least one access point. The network nodes communicate wirelessly with each other and the at least one access point of the mesh network system. The network manager manages operation of a wireless mesh network including the nodes and the at least one access point. The at least one access point communicates wirelessly with the network nodes, and provides a gateway between the wireless mesh network and the network manager. The at least one network access point is operative to synchronize its operation timing to an external clock, such as a UPS or UTC clock. Furthermore, in wireless mesh networks including multiple access points, the access points can synchronize their operation timing to each other, and can provide timing information to other access points and nodes in the network.

### CROSS-REFERENCE TO RELATED APPLICATION

This application claims the benefit of U.S. Provisional Patent Application No. 62/208,196, filed on Aug. 21, 2015 in the U.S. Patent and Trademark Office, the disclosure of which is incorporated by reference herein in its entirety.

### TECHNICAL

This disclosure relates to wireless mesh networks configured to operate using one or multiple access points, and/or configured for precise clock synchronization.

### BACKGROUND

Wireless mesh networks provide a high level of flexibility in network design and in the resulting range of applications that the networks can be used for. In a mesh network, nodes automatically detect and establish communications with neighboring nodes to form the wireless mesh. A network access point (AP) serves as a gateway between the wireless mesh network and elements external to the mesh network. A network manager can coordinate the operation of the wireless mesh network, such as to coordinate the timing of the nodes and establish communication links between nodes.

In one example, nodes of a wireless mesh network each include a sensor and are operative to relay sensor data measurement through the network. In the example, a network access point (AP) provides an interface between the wireless mesh network and an external network (e.g., a local area network (LAN)), and enables a computer connected to the external network to receive the sensor data measurement from all of the wireless mesh network nodes.

Designers and manufacturers of wireless mesh network equipment have developed advanced wireless network nodes, access points, and network managers that are capable of providing a variety of network services. However, such wireless mesh networks operate with limited resources which commonly limit the number of nodes that can form part of a network, and limit the bandwidth available to each node in the network.

For example, standard wireless mesh networks can include only a single network manager (“manager”) and a single active access point (“AP”) communicating with multiple sensor nodes (“motes”). The motes and the AP form a wireless mesh that is prescribed by the manager. However, due to the presence of only a single active AP, the bandwidth of these wireless mesh networks can he limited, the networks may suffer from low reliability in situations in which the single active AP malfunctions or fails, the networks can be disabled by a single point of failure, the networks may be limited by a limit on the number of motes that can be supported by the single manager, and accurate synchronization between physically separated sections of a network can be difficult.

A need therefore exists for wireless mesh networks that can support multiple APs and can provide precise clock synchronization between separate network sections.

### SUMMARY

The teachings herein alleviate one or more of the above noted problems with wireless mesh networks.

In accordance with an aspect of the disclosure, a mesh network system includes a plurality of network nodes, a network manager, and at least one network access point. Each network node includes a processor and a wireless transceiver configured for wireless communication with the other network nodes and access points of the mesh network system. The network manager is communicatively connected to the plurality of network nodes and is configured to manage operation of a wireless mesh network including nodes of the plurality of network nodes. Each network access point includes a processor, a wireless transceiver configured for wireless communication with the network nodes of the mesh network system, and a wired or wireless transceiver configured for communication with the network manager. The network manager and the plurality of network nodes are communicatively connected through the at least one network access point. Furthermore, the at least one network access point is operative to synchronize its operation to an external clock, and to transmit timing information of the external clock to the network nodes of the mesh network system.

The at least one network access point may be operative to synchronize its operation to a GPS clock or a coordinated universal time (UTC) clock serving as the external clock.

The at least one network access point may include a plurality of network access points, and the wireless transceiver of each network access point of the plurality of network access points may be further configured for wireless communication with other network access points of the plurality of network access points.

Multiple network access points of the plurality of network access points may synchronize their operations to a GPS clock or a coordinated universal time (UTC) clock serving as the external clock.

At least another network access point of the plurality of network access points may be operative to synchronize its operation to the timing information transmitted by the at least one network access point of the mesh network system.

The network manager may control each of the plurality of network access points to selectively synchronize its operation to one of the external clock and timing information of advertisement packets transmitted in the wireless mesh network.

The network manager may control a first network access point of the plurality of network access points to transmit timing information of an internal clock of the first network access point to the network nodes of the mesh network system, and the network manager may control a second network access point of the plurality of network access points to synchronize its operation to the timing information received from the first network access point.

The network manager may further control the second network access point of the plurality of network access points to transmit timing information of an internal clock of the second network access point to the network nodes of the mesh network system upon determining that the first network access point has failed.

A first network access point of the plurality of network access points may provide a communication link between the network manager and the plurality of network nodes, a second network access point of the plurality of network access points may be synchronized to a same timing reference as the first network access point, and the second network access point may only provide a communication link between the network manager and the plurality of network nodes in response to determining that the first network access point has failed.

In accordance with a further aspect of the disclosure, a mesh network system includes a plurality of network nodes, a network manager, and a plurality of network access points. Each network node includes a processor and a wireless transceiver configured for wireless communication with the other network nodes and access points of the mesh network system. The network manager is communicatively connected to the plurality of network nodes and is configured to manage operation of a wireless mesh network including nodes of the plurality of network nodes. Each network access point includes a processor, a wireless transceiver configured for wireless communication with the network nodes and other access points of the mesh network system, and a wired or wireless transceiver configured for communication with the network manager. Each network access point of the plurality of network access points is operative to provide a communication link between the network manager and the plurality of network nodes. A first network access point of the plurality of network access points transmits timing information to the network nodes and other network access points of the mesh network. A second network access point of the plurality of network access points synchronizes its operation to the timing information transmitted by the first network access point.

The first network access point may be operative to synchronize its operation to an external clock, and to transmit timing information of the external clock to the network nodes of the mesh network system.

The first network access point may be operative to synchronize its operation to a GPS clock or a coordinated universal time (UTC) clock serving as the external clock.

The first network access point may operate according to an internal clock of the first network access point, and may transmit timing information of the internal clock to the network nodes and other network access points of the mesh network.

The network manager may control the second network access point to transmit timing information to the network nodes and other network access points of the mesh network upon determining that the first network access point has failed.

The first and second network access points may concurrently operate to provide a communication link between the network manager and the plurality of network nodes.

According to a further aspect of the disclosure, a mesh network system includes a plurality of network nodes and a plurality of network access points. Each network node includes a processor and a wireless transceiver configured for wireless communication with the other network nodes and access points of the mesh network system to form a wireless mesh network. The network nodes are configured to manage operation of a wireless mesh network. Each network access point includes a processor, a wireless transceiver configured for wireless communication with the network nodes and other access points of the mesh network system, and a wired or wireless transceiver configured for communication across a wide area network (WAN). Each network access point of the plurality of network access points is operative to provide a communication link between the WAN and the plurality of network nodes. Further, each network access point is operative to synchronize its operation to an external clock, and to transmit timing information of the external clock to the network nodes of the mesh network system.

The plurality of network access points may include first and second network access points that are operative to provide communication links between the WAN and a respective one of first and second sub-sets of the plurality of network nodes, and network nodes of the first sub-set of network nodes may communicate with the network nodes of the second sub-set of network nodes through the WAN only.

The plurality of network nodes may be configured to manage operation of a wireless mesh network by establishing a communication schedule for the wireless mesh network.

Each network access point may be operative to synchronize its operation to a GPS clock or a coordinated universal time (UTC) clock serving as the external clock.

The plurality of network nodes may share a common network identifier (ID) and network addresses that are compatible for use in the same network.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, :like reference numerals refer to the same or similar elements. Details that may be apparent or unnecessary may be omitted to save space or for more effective illustration. Some embodiments may be practiced with additional components or steps and/or without all of the components or steps that are illustrated.

FIGS. 1A and 1B illustrate examples of networks with wireless multiple access points, wireless motes, a GPS time source, a manager, and a host application.

FIGS. 2A and 2B illustrate example of interconnections between network managers and APs in an illustrative embodiment.

FIGS. 3A-3C are high-level functional block diagrams of an illustrative wireless node, an illustrative access point, and an illustrative network manager, respectively, that may be used in the wireless mesh network systems of FIGS. 1A and 1B.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various systems and methods disclosed herein relate to wireless mesh networks, and particularly to wireless mesh networks configured for operation using one or multiple access points and/or configured for precise clock synchronization between access points and motes.

Reference now is made in detail to the examples illustrated in the accompanying drawings and discussed below.

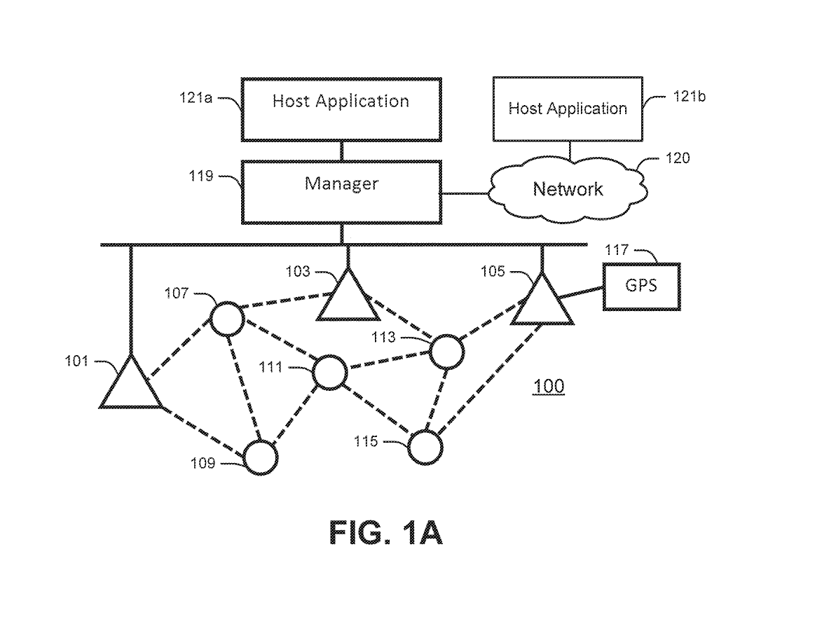

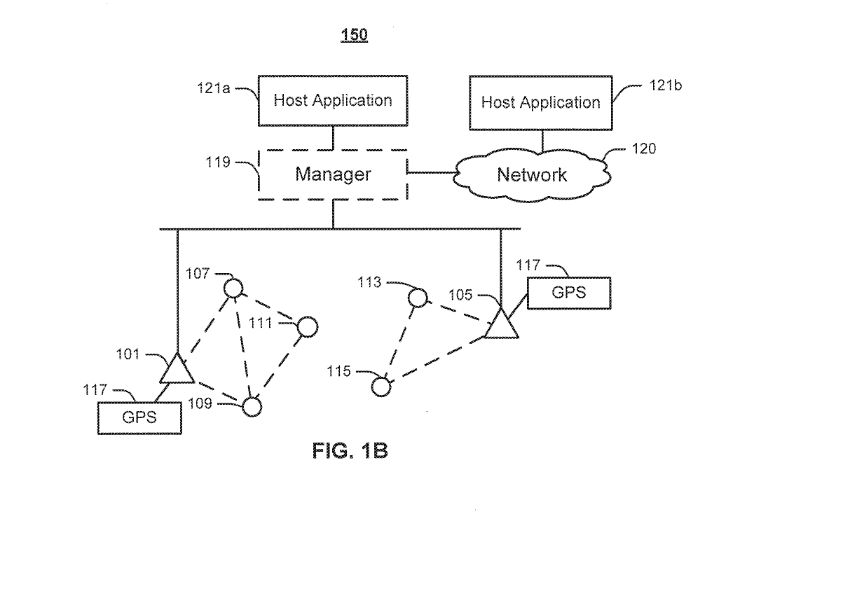

FIG. 1A shows an illustrative wireless mesh network 100 that includes a plurality of wireless mesh network nodes 107, 109, 111, 113, and 115, also referenced as motes, that communicate with each other through wireless links (shown in dashed lines). Each node or mote includes a wireless transceiver. A node operating as a sensor node includes a sensor and generates data packets including sensor measurement data for transmission across the wireless mesh. The same or another node can operate as an actuator or control node that includes an actuator or controller and receives control packets through the wireless mesh.

The wireless mesh network 100 additionally includes one or more wireless access points (APs) 101, 103, and 105. An AP can have wireless links to both nodes and to other APs. Additionally, each AP serves as an interface or gateway between the wireless mesh network 100 (including nodes 107, 109, 111, 113, and 115) and elements external to the mesh network. For example, the APs may provide an interface between the wireless mesh network 100 and an external network (e.g., 120) that may be wired or wireless. In the example shown, the APs communicate with a network manager 119 across wired links (shown in solid lines) and with one or more host applications 121a and 121b. The communications of the APs with the network manager 119 and/or host applications 121a and 121b may be routed through an external network 120 such as the Internet. Note that the communication links between the APs, network manager 119, and/or host applications 121a and 121b may be wired links or wireless links such as WiFi or cellular connections.

The network manager 119 coordinates the operation of the wireless network devices (nodes and APs) to efficiently communicate with each other, and assigns bandwidth (e.g., channels and timeslot pairs) and network addresses (or other unique identifiers) to network nodes and APs to enable coordinated network communication. In detail, the network manager 119 is responsible for controlling operation of the wireless mesh network 100. For example, the network manager 119 may establish and control network timing (e.g., by selecting whether the network will function according to an internal clock of an AP or an external clock, and configuring the APs to synchronize to the appropriate selected clock). The network manager 119 may also determine which devices (e.g., nodes and access points) can participate in the network by selectively joining nodes and access points to the network, assigning network addresses (or other unique identifiers (ID)) to the joined devices, and setting the communication schedule for the network by assigning bandwidth to different devices of the network. The communication schedule may assign pairs of timeslots and channels to the devices (e.g., wireless nodes 107 and APs 103) of the network, to thereby identify which device can communicate on each channel during each timeslot of the network clock. Additionally, the communication schedule may assign pairs of timeslots and channels that form a “join listen.” bandwidth during which wireless nodes seeking to join the network can send network join messages, and during which wireless nodes already joined to the network listen for such network join messages.

One or more of the APs 101, 103, and 105 may optionally be communicatively connected to an external time source such as GPS time source 117. In FIG. 1A, for example, AP 105 is connected to the UPS time source 117 to enable the AP 105 to synchronize its clock to the UPS time reference. In this respect, AP 105 is externally clocked. In one example, the other APs 101 and 103 may receive a clock reference, such as a clock reference synchronized to the UPS time source 117, from wireless communication with the mesh network.

In operation, data generated in the mesh network nodes 107, 109, 111, 113, and 115 may flow through the mesh network 100 to any of the APs 101, 103, and 105. Additionally, data generated at the network manager 119 or host application 121a, 121b for transmission in the mesh network 100 may flow, equivalently, from any of the APs 101, 103, and 105 to its destination node.

The wireless mesh sensor network 100 enables the collection of sensor measurement data (and/or application data) from multiple sense points at which sensor nodes are located. The network 100 enables the collection of sensor data by building a multi-hop mesh of communication links using the nodes. Data sent from distant nodes may be automatically routed through the mesh by having each node retransmit received packets topologically closer to each packet's destination. Alternatively, each node may retransmit received packets on the node's next communication opportunity, as determined based on a network node communication schedule established by the network manager 119 for the network, regardless of the destination node associated with the next communication opportunity. Each transmission and reception of a packet between a pair of nodes may be called a hop, and data packets may take different multi-hop routes through the mesh to their destination. In general, the destination of a packet including sensor data transmitted from a node in the mesh network is the AP of the wireless mesh network 100, and the route followed by the packet depends on path stability and the network node communication schedules. By a similar process, sensor application data and other packets (e.g., from the host application 121a, 121b) propagate through the mesh network in the opposite direction, e.g. from an AP to a sensor node serving as a destination node.

In a wireless mesh network having a single AP (e.g., 103), the network may be established and begin operation when the AP is powered up and receives a network identifier and network node communication schedule indicative of the network's wireless links from the network manager 119 over the wired AP-manager interface. After receiving the network identifier and network node communication schedule, the single AP may be responsible for setting the time reference in the network, and may begin sending out network advertisements based on the AP's own time reference (e.g., the AP's internal clock) in advertisement packets which serve both to advertise the network and to enable nodes seeking to join the network to synchronize their clocks to the network time reference set according to the AP's clock.

When a node is first powered up, the node may go through a mesh network searching and joining process. The first part of the searching and joining process may involve the node listening for advertisements from any existing mesh networks in its vicinity and synchronizing its internal time reference (e.g., clock) to the time reference of a wireless mesh network from which an advertisement packet is received. Once synchronized, the node engages in a security handshake with the manager 119 of the wireless mesh network it is seeking to join. The security handshake may involve exchanging multiple packets, which are sent back-and-forth through the wireless mesh, between the joining node and the manager 119. At the end of this handshaking, the manager 119 may add wireless links in the network node communication schedule to provide opportunities for the joining node to receive and/or send packets through the wireless mesh network, so as to allow the joined node to participate in the network and to advertise for other nodes to join.

In early implementations, the joining/joined node tracked network time reference, and the network time reference was set according (and correspondingly reflected) the internal clock of the AR The manager 119 could translate the network time reference to coordinated universal time (UTC). However, because of clock drift between the network time reference and UTC, the resolution of the clock translation was much lower than the device-to-device time synchronization. Further, in cases in which the translation was performed directly in network nodes, loss of accuracy and fidelity was severe.

As described in relation to FIG. 1A, the wireless mesh network 100 can include multiple APs e.g., 101, 103, 105). In such a network, the network has multiple egress points for packets to pass from the wireless mesh network 100 to a manager 119 or host application 121a, 121b, and multiple ingress points for packets to pass from the manager 119 or host application 121a, 121b to the nodes in the wireless network. As such, the network may be able to support more packets per second being received from the network and more packets per second being sent into the network. Furthermore, the network may exhibit higher reliability since, unlike a network having a single AP, the network does not have a single-point-of-failure (in the network having a single AP, a failure of the AP will inhibit further network operation).

Additionally, the use of multiple APs may enable the network to support more nodes with a single manager 119 than a corresponding network having a single AR In one example, a wireless mesh network having a single AP may be able to support a maximum number of nodes (e.g., 100 nodes) and a maximum throughput (e.g., 36 packets per second of upstream data) based on constraints imposed by the network hardware, communication and network protocol, and the like. Further, the network having the single AP may fail completely if the network's AP fails. However, by installing multiple APs (e.g., 12 APs) in the single network, the manager may be able to support more nodes (e.g., 12*100=1200 motes in our example) and more data throughput (e.g., 12*36=432 packets per second of upstream data) under the same conditions. Furthermore, if any of the multiple APs (e.g., 12 APs) fail, the network may be able to continue to operate with only a small decrease in available performance, which may or may not affect the host application.

However, for a network having multiple APs, all APs and nodes may need to operate according to a same time reference in order for the network to function efficiently. Indeed, for all APs and nodes to communicate according to the same network communication schedule, the APs and nodes should be synchronized to the same time reference used to determine the current point in time in the network communication schedule. Hence, the multiple APs in the network will generally need to agree on the current network time e.g. to within a few microseconds), such that all APs can be synchronized. In turn, since the multiple different APs send out network advertisement packets to which joining nodes (and joined nodes) synchronize their communications, the synchronization in the APs will result in the nodes joining the network through the same or different APs being synchronized to each other and to the network time reference.

Two approaches are provided for synchronization between APs in a wireless mesh network.

In accordance with a first approach, one AP among the multiple APs in the wireless mesh network is designated as providing the time reference. The designated AP may use its own internal time reference (e.g., its own internal clock) as the network time reference, and the other APs in the network may synchronize their operations to the designated AP's internal time reference.

In accordance with a second approach, an external time reference can be used. For example, a GPS time reference (e.g., 117), UTC time reference, or other accurate time base may be used. In the example of FIG. 1A, one AP 105 may be in direct communication with the external time reference and may synchronize its clock to the external time reference. In turn, the AP 105 may advertise the time reference to enable other APs in the network to synchronize their operations to the advertised time reference. In other examples, multiple APs may be in direct communication with the external time reference and may synchronize their clocks to the external time reference. In the other examples, any remaining APs that cannot directly communicate with the external time reference may synchronize their operations to the time reference advertised by other APs in the network (e.g., other APs that are in direct communication with the external time reference).

In general, if a network has at least one AP that is synchronized to an external clock, then no other AP in the network can be synchronized to an internal clock. Instead, all network APs must either be synchronized to the same external clock, or synchronized to the network clock (as advertised by APs joined to the network) which tracks the external clock. For example, APs can be synchronized to timing information provided in advertisement packets transmitted from APs and nodes that are synchronized to the external clock or the network clock. Similarly, if a network has one AP that is synchronized to a local/internal clock, then all other APs in the network must be synchronized to the network time based on advertisements transmitted from the one AP.

In cases in which the network time is set according to an external time reference and the APs are synched to such an external clock, the time reference used by each network node may track the external clock (e.g., UTC time or other accurate time base). The synchronization to the external time reference may be especially useful in situations in which a single network managed by a single manager includes physically separated clusters of devices (sub-nets), for example in a situation in which each of the multiple APs is in a geographically distinct location and serves as a network gateway for a set of network nodes in the geographically distinct location, as illustratively shown in FIG. 1B (discussed in further detail below).

FIG. 1B shows an illustrative wireless mesh network 150 that is similar to the wireless mesh network 100 of FIG. 1A, arid components and functions of the network 150 operate in substantially similar ways as corresponding components of the network 100. In the network 150, the nodes and APs form physically separated clusters of devices, and devices of one cluster (sub-net) can only communicate with the devices of another cluster (or sub-net) through the wired communication link between the APs (e.g., 101 and 105). In such situations, the APs (e.g., 101 and 105) may not communicate with each other through direct wireless communication, and the use of an external time reference 117 may enable each AP to synchronize to the external time reference (e.g., UTC time or GPS time) to thereby maintain accurate time synchronization across all nodes and devices in the geographically distinct locations. In particular, at least one AP in each geographically distinct location may be synchronized to the external clock to ensure precise time synchronization between the different locations, and the remaining APs in each location may either be synchronized to network time or to the external clock.

In the case of geographically distributed mesh networks, as well as in the case of geographically integrated mesh networks, a single mesh network may be defined based on the following criteria. Two devices (e.g., APs or nodes) may be considered to be in the same network if: the devices share a common time reference that is sufficiently precise to enable the devices to communicate with each other wirelessly; the devices share a common network communication schedule, a common network ID, a common security protocol (including encryption/decryption/security keys), a common frequency blacklist, and are assigned network addresses (or other unique identifiers such as MAC addresses or node IDs) that are compatible for use on the same network; and/or the devices can communicate with each other and have been assigned opposite transmit and receive links in the same time slot and on the same channel offset in a network node communication schedule.

In operation, at the time of joining a wireless mesh network, an AP may be synchronized to the proper network time. This can be a requirement in networks that operate according to time-synchronized channel hopping (TSCH) rules and in which all wireless communications follows one or more periodic schedules. In general, nodes synchronize to the proper network time by listening to advertisement packets from devices already in the network. APs can synchronize in the same manner as the nodes (e.g., by listening to advertisement packets from devices already in the network), but may additionally or alternatively use an external time source for synchronization in cases in which the external time source provides high accuracy and high precision. As such, an AP may synchronize directly with other devices in the network, or the AP can synchronize with a UTC or UPS time source, for example, if one is available. Specifically, a network PLL algorithm running in a node or AP can be used to track the time source based on series of time updates provided from devices already in the network or from the external time source.

With reference to tracking an external time source, an AP (e.g., 105) may synchronize itself to an external time source (e.g., 117) by listening to a Pulse-Per-Second (PPS) signal from a Global Positioning System (GPS) receiver. The AP may, for example, train the AP internal clock to cross each second exactly on the rising edge of the PPS. This synchronization may ensure that the AP knows when a new second occurs, but the AP may nonetheless not know which second and may thus not be fully synchronized to the network. In order to identify which second is associated with each rising edge of the PPS, a Network Time Protocol (NTP) clock running as a service on a Unix machine may be queried on the hardware. Alternatively (or additionally), the current second can be determined from the GPS signal or any other reasonably accurate current time source (e.g., any time source that is accurate to within tens of milliseconds). In one example, the network time of a wireless mesh network may be fixed to begin at a constant time (e.g., 20:00 UTC on Jul. 2, 2002, which corresponds to Absolute Time Slot Number 0 (ASN0)). Thus, based on knowledge of the current time relative to ASN0, the current network time can be determined.

Once all APs operating in the wireless mesh network are synchronized to the same external time source (e.g., a globally accurate time source), the APs may agree on the time having elapsed since ASN0. Each AP may maintain a lock to the PPS signal so as to precisely maintain its sense of time without being subject to any internal clock drift for the lifetime of the device in the network. Thus, each AP may be synched using an external time source. In turn, individual nodes' time references may be synchronized to the time reference of the APs based on advertisement packets transmitted by the APs, such that the individual nodes' time references are synchronized to within a few microseconds of the reference clock (e.g., the reference clock providing UTC time).

As discussed above, an alternative method for synchronization between APs in the network may involve APs listening for advertisements from devices (e.g., nodes and other APs) already in the network. The advertisement packets each include a network ID uniquely identifying the network they are associated with, and a receiving AP or node may thus filter received advertisements by network ID according to the network that the joining AP or node is looking for. Different networks may also have different security keys, so not all devices (nodes and APs) may be able to join all networks. The advertisement packet may contain current time information (relative to ASN0). A joining AP may wait to hear multiple advertisements or may solicit time updates by sending wireless packets to the advertising devices (e.g., keep alive packets), in order to train its clock to be synchronized to the network time. After the joining AP's clock has converged sufficiently close to the network time, the joining AP may initiate the handshake process with the network manager.

As part of the joining process, the network manager 119 may provide the joining AP with links to existing devices, which can be nodes or APs. The joining AP can then send keep alive packets along those links to continue to receive time updates for the lifetime of the device in the network. Note that an AP will synchronize to network time only if the network already has at least one AP setting the network time. In the case of the first AP to join a network, the AP may be tasked by the network manager 119 to set the network time reference.

Once a joining AP has synchronized to network time, the joining AP may query the network manager 119 directly over the AP-manager interface and execute a joining handshake. This process may be different from that used by nodes joining the network, since a joining node may need to exchange a series of handshake packets with the network manager 119 via the wireless mesh network 100 with an AP serving as an intermediary via-point between the joining node and the manager. The joining handshake for a multiple AP system may be the same as that for a single AP system: in response to the new device identifying itself as an AP, the manger can assign links in the network node communication schedule to the joining AP and provide the network node communication schedule to the joined AP to cause the joined AP to start advertising in the network by transmitting advertisement packets at the time and on the channels identified in the schedule.

Each AP may have a unique long identifier, such as 8-Byte EUI-64 which is not assigned to any other device in the world. When the AP joins a network, the AP may provide its unique long identifier to the network manager 119 during the hand shaking process. The AP is then generally assigned a short identifier (e.g., a 2-Byte node ID) by the network manager 119 for use in the mesh wireless network 100 that the AP is joined to. The short identifier is unique to the wireless mesh network that the AP is jointed to. Similarly, nodes may be given short identifiers (e.g., a 2-Byte node ID) when joined to the network, and may use the short identifiers for communication in the network. In a single AP network, the single AP may be given node ID=1, and remaining IDs (e.g., 2, 3, . . . ) may be assigned to the network nodes. In contrast, in a multiple AP network, no particular identifiers are assigned to the APs or the nodes. In both cases, the manager may maintain a map between the long ID and the node ID for each device.

As detailed below, the use of multiple APs in the network may provide increased bandwidth and increased redundancy leading to improved reliability. The improvement in bandwidth may be especially notable in cases in which the devices in the network (e.g., APs and nodes) have only a single radio transceiver and therefore can transmit or receive only one packet at a time. Consequently, when a single AP operating at maximum capacity, the AP can only send or receive one packet per timeslot and this may thus limit the bandwidth between the manager 119 and the nodes in the wireless mesh network 100. By adding a second AP, the network may approximately double the capacity of packet transfer to and from the wireless mesh network, and adding additional APs may linearly increase the network capacity.

The network bandwidth may be used not only to transport packets of application data between nodes and APs, but also for traffic of keep alive packets used to keep nodes synchronized to the network. Keep alive packets are packets that are periodically sent in the wireless mesh network to maintain synchronization between nodes, as described in more detail in U.S. Pat. No. 8,953,581 which is incorporated herein by reference in its entirety. Thus, by increasing the number of APs in the network, the network advantageously also increases the number of nodes that can be supported in a network. Note that the increase in the number of nodes may reach an upper limit set by physical radio space limitations and the device density, so it may not be feasible to arbitrarily keep adding APs and motes to a small limited geographical area.

In networks configured for use with multiple APs, the networks can nonetheless function with only a single externally clocked AP. As a result, in a network having multiple externally clocked APs, the network can maintain operation even if the network loses all-but-one of the APs so long as the nodes remaining in the network are within radio reach of each other. Limitations may occur in eases in which the APs are located far apart, in which the mesh network contains holes (e.g., as a result of large distances groups of nodes that cannot wirelessly communicate with each other, and thus cannot all route their data to the same AP). In such geographically extended networks, externally clocked APs can be placed such that a pair of APs is located in each geographically isolated section (sub net) of the mesh wireless network to ensure that the network can continue operation without losing any nodes even if any single AP fails.

The foregoing discussion has focused on networks having a network manager 119 operative to coordinate the operation of the wireless network devices (nodes and APs) to efficiently communicate with each other. In some examples, a mesh wireless network may include multiple network managers. Alternatively, as illustratively shown by its dashed outline in FIG. 1B, the manager may optionally not be provided in the network system 150. In such a network system 150 that does not include a standalone network manager, the network nodes and/or APs may jointly manage operation of the wireless mesh network, for example by jointly establishing the communication schedule for operation of the wireless network.

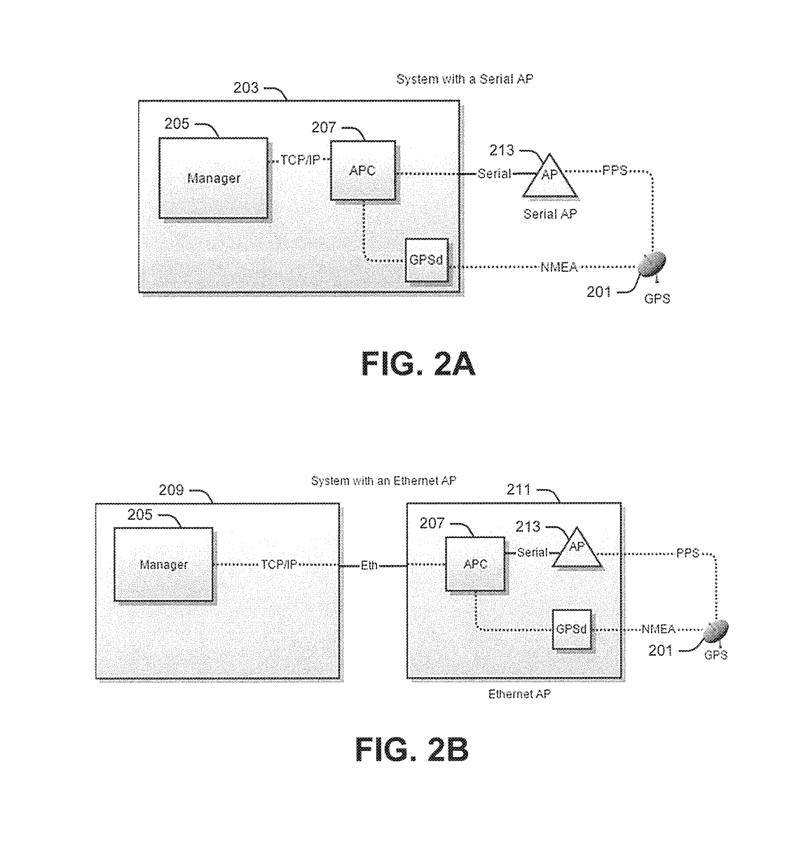

FIGS. 2A and 2B illustrate an example of a serial AP (FIG. 2A) and an Ethernet AP (FIG. 2B) taking external time from a GPS source 201. In the serial AP case (FIG. 2A), the current time may be maintained on the same hardware system (e.g., computer) 203 as the manager 205 and AP controller 207. In the Ethernet AP case (FIG. 2B), the manager 205 may be on one hardware system (e.g., computer) 209 and the current time may be maintained on another hardware system (e.g., computer) 211 with the AP controller 207 and AP 213. In both cases, the rising edge of the GPS PPS may be sampled directly by the AP.

An illustrative use example of a wireless mesh network will now be described. In the example, the wireless mesh network has three APs and two sensor nodes. Two APs (AP1 and AP2) are synchronized to an external UPS clock (e.g., 117), and the third AP (AP3) is synchronized to network time.

Initially AP1 boots up and synchronizes its internal clock to the external time reference clock, the GPS clock (e.g., 117). In detail, based on the timing signal received from the external time reference, AP1 synchronizes its clock to the external time reference clock and determines the current time elapsed since a predefined time reference point (e.g., ASN0). AP1 thus has acquired the current second and has the current time elapsed since ASN0. Once synchronized, AP1 initiates a network joining handshake with the network manager (e.g., 119) over the AP-manager interface e.g., over a wired link). If the network manager joins AP1 to the network, the network manager establishes (or adjusts) the network node communication schedule to include communication links (corresponding to pairs of time slots and channels) for communications to and from the AP over the mesh wireless network. The network manager then communicates the network ID, a unique node ID, and the network node communication schedule to the joined AP1. Once in receipt of the network ID, node ID, and schedule, AP1, begins generating and transmitting advertising packets during advertising time-slots identified in the network node communication schedule.

A first node, Node1, may hear the advertising packet transmitted by AP1. Based on timing information for the network time reference included in the advertising packet, Node1 synchronizes itself to the network time reference and, once synchronized, generates and transmits to AP1 a network join packet during an appropriate time-slot of the network communication schedule. The join packet is forwarded by AP1 to the network manager. The network manager optionally engages in a joining handshake with Node1, and, if the network joining process is successful, joins Node1 to the wireless mesh network. The network manager may then revise the network node communication schedule to include communication links for communications to and from Node1 over the mesh wireless network. The revised schedule is communicated to AP1 and Node1, and unique Node ID is further communicated to Node1. Node1 can then begin operation on the network.

A second AP, AP2, may boot up and synchronize its internal to the external time reference clock. Through the synchronization process, AP2 acquires the current second and the current time elapsed since ASN0. Once synchronized, AP2 handshakes with the manager over the AP-manager interface. If the network manager joins AP2 to the network, the network manager revises the network node communication schedule to include communication links for communications to and from AP2 over the mesh wireless network. The network manager then communicates the network ID, a unique node ID, and the revised network node communication schedule to the joined AP2. Once in receipt of the network ID, node ID, and schedule, AP2 begins generating and transmitting advertising packets during advertising time-slots identified in the network node communication schedule.

A third AP, AP3, may hear a network advertisement (advertising packet) transmitted by AP2. Based on timing information included in the network advertisement, AP3 synchronizes its clock to the network time reference and calculates the current time elapsed since ASN0. Once synchronized to AP2 and in receipt of the network ID from the network advertisement received from AP2, AP3 handshakes with the manager over the AP-manager interface. If the network manager joins AP3 to the network, the network manager revises the network node communication schedule to include communication links for communications to and from AP3 over the mesh wireless network. The network manager then communicates a unique node ID and the revised network node communication schedule to the joined AP3. Once in receipt of the node ID and schedule, AP3 begins generating and transmitting advertising packets during advertising time-slots identified in the network node communication schedule.

A second node, Node2, may hear an advertising packet transmitted by AP3. Based on timing information for the network time reference included in the advertising packet, Node2 synchronizes itself to the network time reference and, once synchronized, generates and transmits to AP3 a network join packet during an appropriate time-slot of the network communication schedule. The join packet is forwarded by AP3 to the network manager. The network manager optionally engages in a joining handshake with Node2 and, if the network joining process is successful, joins Node2 to the wireless mesh network. The network manager may then revise the network node communication schedule to include communication links for communications to and from Node2 over the mesh wireless network. The revised schedule and a unique Node ID are communicated to Node2. Node2 can then begin operation on the network.

During operation, Node1 may discover AP2 as a result of engaging in a periodic or regular network discovery process. For example, Node1 may receive an advertising packet from AP2. In response, Node1 reports the received advertising packet to the network manager through the wireless mesh network. The network manager then revises the network node communication schedule to include communication links for communications between Node1 and AP2 over the mesh wireless network.

In turn, even if AP1 and AP3 fail, the wireless mesh network including Node1 and AP2 can continue operation. Note that in order to continue operation, Node2 will need to have a wireless link with one or more nodes or APs remaining in the network, such as Node1 and AP2.

As discussed above, instead of using an external time reference, a network having multiple APs can use one designated AP's internal clock to set the network time reference. The designated AP serves as the time master AP of the network. In such a network, all APs will synchronize their clocks to the one designated time master AP's internal clock based on timing information included in advertisement packets and keep alive packets transmitted by the time master AP and by nodes and APs synchronized to the time master AP. If any node or AP other than the time master AP is lost, the network can generally continue to operate with the remaining nodes and APs. However, if the time master AP is lost, the network manager 119 automatically designates another AP remaining in the network to serve as the time master. The network manager 119 may designate an AP at random, designate the AP having been joined to the network for the longest amount of time, designate the AP having the lowest short identifier, or the like.

Alternatively, in order to achieve redundancy in the APs, two APs in a wireless mesh network having multiple APs can be respectively pre-designated as a timing master and a timing slave APs. In an example, a first AP, AP1, is designated to operate as the timing master and a second AP, AP2, is designated as the timing slave. In the example, AP1 actively participates in the network and serves as the timing master. Meanwhile, AP2 is synchronized to the network time reference but does not participate in the network (e.g., does not receive or transmit data packets); instead, AP2 waits for the primary AP1 to fail and, once failure of AP1 is determined, takes over the role of AP1 for communication in the network. In this regard, AP1 and AP2 operate in individual mode in which only one of the APs is operative at any time. In this example, the entire network performance (latency, bandwidth) is advantageously preserved even in the face of a failure of AP1.

In another example, AP1 is designated to operate as the timing master and AP2 as the timing slave. However, AP1 and AP2 both actively participate in the network, and thereby provide more ingress and egress bandwidth and lower latency for the network when they are both working. However, if either AP1 or AP2 fails, the AP that remains active can sustain network connectivity for any nodes that have 1-hop or multi-hop routes to the remaining AP. AP1 and AP2 thereby operate in a redundant mode in which they can both operate simultaneously. In this example, the ingress and egress bandwidth of the network may decrease and the network latency may increase as a result of one of the APs failing.

In order to provide APs operating in a wireless mesh network the ability to operate as detailed in the foregoing paragraphs, each AP may include two switches: a first switch designating the AP as a timing master or timing slave, and a second switching designating operation in individual or redundant mode. The switches may be physical switches that are set by a network operator, for example while setting up a network. The switches can alternatively be software switches that are either set by a network operator upon initial device configuration or during network set-up, or set by a network manager during network set-up or during network operation.

In a further example, the APs may further operate in an automatic-clock-source mode. These APs may include a switch for selecting the automatic-clock-source mode, or may be configured by a network operator at the time of manufacture, during network setup, or during network operation to operate in the automatic-clock-source mode. An AP operating in the automatic-clock-source mode will have its operating mode set by the network manager 119). For example, the AP may report to the network manager that it operates in the automatic-clock-source mode at the time of joining the network. The network manager may then determine whether the AP should synchronize to its internal clock, an external clock, or the network clock. In practice, the manager may assign the first AP joining the network (and operating in the automatic-clock-source mode) to operate according to its internal clock, and may assign the remaining APs joining the network to operate according to the network clock in order to cause the remaining APs to synchronize themselves to the first AP's internal clock. Alternatively, the manager may assign the first AP joining the network (and operating in the automatic-clock-source mode) to operate according to an external clock, and may assign the remaining APs joining the network to operate according to either the external clock or the network clock (in order to cause the remaining APs to synchronize themselves to the first AP's clock, which is synchronized to the external clock). In a further example, in the automatic-clock-source mode in which the network is synchronized to one AP's internal clock, the network manager may consider the topology of the network (and in particular the connectivity of each AP to the different network nodes) in order to select which network AP should be used as the time reference if the one AP fails. In this case, in the event that the one AP fails, the network manager can promptly set the selected AP to synchronize to its internal clock and the network can then continue to operate using the newly selected AP's internal clock as the network time reference. This method of operation provides a high degree of redundancy.

In summary, the wireless mesh network operating with multiple APs present the following advantages. First, by enabling APs to time synchronize to external time sources having high accuracy, such as a UTC or UPS time sources, APs and network nodes can reach a high degree of time synchronization even in geographically dispersed networks. Once synchronized, an AP joins the wireless mesh network using a handshake over an AP-Manager interface. Second, an AP can alternatively be configured to time synchronize to an advertisement from a device (e.g., another AP or a network node) already in the wireless mesh network. In this way, APs do not necessarily need to be operative to communicate with external time sources, and can operate even if a communication link to an external time source is not available. Again, once synchronized, the AP joins the wireless mesh network using a handshake over the AP-Manager interface. Third, in a wireless mesh network, that has multiple APs, and in which one or more of the APs is synchronized to an external accurate time source or is designated as a timing master, the network can continue to operate without any data communication loss even in the face of a failure of any of the other APs. Fourth, in a wireless mesh network that has at least one AP synchronized to an external clock and in which multiple nodes are dispersed in geographically separate locations (each separate geographic location having at least one AP), the synchronization to UTC or UPS time enables all nodes to take simultaneous measurements or to otherwise perform simultaneous or synchronized operations with high time accuracy.

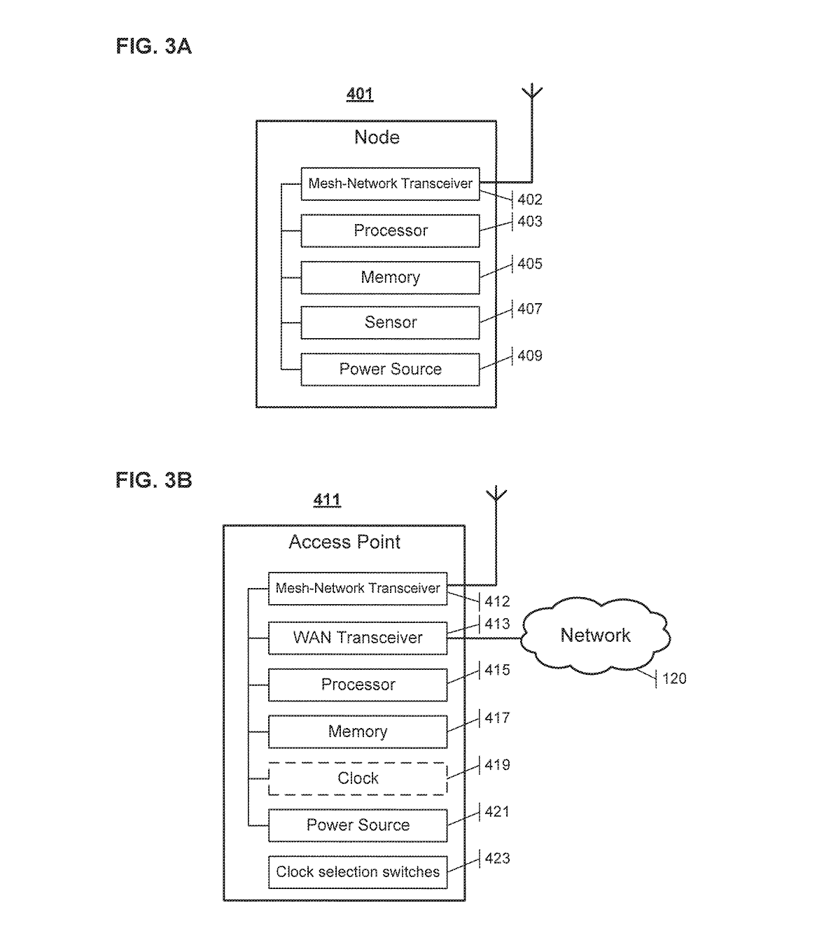

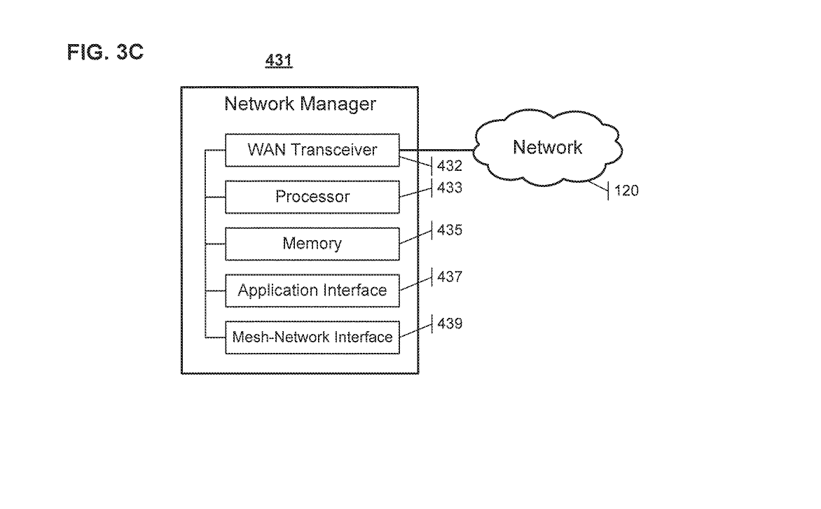

FIGS. 3A-3C show high-level functional block diagrams of illustrative components or devices of the wireless mesh network systems of FIGS. 1A and 1B. FIG. 3A shows an example of a node 401 such as a node 107, 109, 111, 113, or 115 used in the network systems of FIGS. 1A and 1B. The node 401 includes a processor 403 (e.g., a microprocessor) and a memory 405 that provide processing capabilities. The memory 405 stores application programs and instructions for controlling operation of the node 401, and the processor 403 is configured to execute the application programs and instructions stored in the memory 405. A power source 409, such as a battery, transformer, solar cell(s), dynamo, or the like, provides electric power for powering the operation of the node 401.

Additionally, the node 401 can include a sensor 407 producing sensing or measurement data that is provided to the processor 403 and/or stored in memory 405. The node 401 can additionally or alternatively include an actuator (e.g., a motor, valve, or the like) or other operational output a display) that is controlled by the processor 403. The node 401 further includes a transceiver 402 that enables communication across the network (e.g., a wireless mesh-network) with other nodes 101 or APs 103. As shown in FIG. 3A, the transceiver 401 is a wireless transceiver 401 connected to an antenna and configured for wireless communication; in other embodiments, the transceiver 401 may be a wired transceiver. The various components of the node 401 are communicatively connected to each other (e.g., via a bus or other communication lines), and are electrically connected to the power source 409 to receive operating power.

FIG. 3B shows a high-level functional block diagram of an example of an AP 411 such as APs 101, 103, and 105 used in the network systems of FIG. 1A and 1B. The AP 411 includes components substantially similar to those of the node 401, including a mesh-network transceiver 412, a processor 415 (e.g., a microprocessor), a memory 417, an optional sensor, and a power source 421. Such components of the AP 411 are substantially similar to corresponding components of the node 401, and reference can be made to the description of the node 401 for detailed information on the components and their function. The AP 411 optionally includes a sensor, actuator, or other operational output that is controlled by the processor 415, similarly to the node 401.

Additionally, the AP 411 can include dual transceivers: a first transceiver 412 (e.g., a mesh-network transceiver) configured for communication with wireless nodes of the wireless mesh network, and a second transceiver 413 (e.g., a WAN transceiver configured for communication outside of the mesh-network such as communications with the network manager 119 or application(s) 121a/112b (e.g., via the network 120). In our example, the first transceiver 412 may be a wireless transceiver, while the second transceiver 413 may he a transceiver configured for wired communications (e.g., a transceiver compatible with Ethernet standards) directly with the network manager 119 or indirectly via one or more network(s) 120. While two transceivers are shown in FIG. 3B, some embodiments may include a single transceiver performing both communications functions, while in other embodiments communications with the network manager 119 may be via a direct wired link.

The AP 411 can further include a clock 419, also referenced as an internal clock, used to control timing of operation of the AP 411. The AP 411 can also communicate with an external clock (e.g., 117), either through the second transceiver 413 or through a dedicated port (or dedicated built-in UPS receiver). The AP 411 can thus be operative to synchronize its operation to its internal clock, an external clock, or to timing information received through communications with a wireless mesh network. Clock selection switches 423 can be used to select whether the AP 411 functions in an automatic clock selection mode, in which the network manager 119 selects whether the AP synchronizes its operations to an internal clock, an external clock, or a network clock, or a manual clock selection mode in which the AP itself determines whether it synchronizes to the internal clock, the external clock, or the network clock. The clock selection switches 423 can further include a switch for selecting whether the AP functions as a timing master or timing slave, and a switch for selecting whether the AP functions in a redundant or individual AP mode.

In both FIGS. 3A and 3B, the sensors 407 and 409 are shown as being located within the node 401 and AP 411. More generally, the sensors 407 and 409 may be external to the node 401 and AP 411, but may be connected to the node 401 and AP 411 so as to communicate sensor data to the node 401 and AP 411.

FIG. 3C shows a high-level functional block diagram of an example of a network manager 431 such as network manager 119 used in the network systems of FIGS. 1A and 1B. The network manager 431 controls operations of the mesh network, and serves as an interface between the network and the outside (e.g., as an interface between the network and external application(s) 121a/121b). Specifically, all communications between the mesh network and external applications 121a/121b may flow through the network manager 431, or otherwise be controlled by the network manager 431.

The network manager 119 is shown in FIGS. 1A and 113 as being a separate entity from the APs 101, 103, and 105 and as being physically separate from the APs. In such embodiments, the network manager 119 and AP(s) are separate entities and may be communicatively connected via a communication cable (as shown), one or more wired or wireless network(s), and/or one or more wireless communication links. In other embodiments, the network manager 119 may be co-located with one AP, for example within a same device casing. In such embodiments, the network manager 119 and AP may have distinct processors, may be mounted on distinct circuit boards, and may be communicatively connected by wire traces between the circuit boards. In further embodiments, the network manager 119 may execute on a same processor as an AP.

The network manager 431 includes a processor 433 (e.g., a microprocessor) and a memory 435 that provide processing capabilities. The memory 435 stores application programs and instructions for controlling operation of the network manager 431, and the processor 433 is configured to execute the application programs and instructions stored in the memory 435 and control operation of the manager 431.

Additionally, the network manager 431 includes a communication interface such as a transceiver 432 for communication via network(s) 120. While a single transceiver 432 is shown in FIG. 3C, the network manager 431 can include multiple transceivers, for example in situations in which the network manager 431 communicates using different communications standards or protocols, or using different networks or communications links, with the AP(s) and/or the application(s) 121a/121b. For instance, a dedicated communication interface 439 (e g., a dedicated port) can be included for communication with the AP(s) of the mesh network. As shown in FIG. 3C, the transceiver 432 is a wired transceiver connected to network 120; in other embodiments, the network manager 431 includes one or more wireless transceivers connected to antennas and configured for wireless communication.

The various components of the network manager 431 are communicatively connected to each other (e.g., via a bus or other communication lines), and are electrically connected to a power source to receive operating power.

The network manager 431 provides oversight of the mesh network, and can control operation of the network. For example, the network manager 431 joins nodes to the network, sets network timing and/or sets a network communication schedule, and performs other network administration based on program instructions stored in memory 435 and executed on processor 433. In addition, as part of joining nodes and APs to the network, the network manager 431 can receive identification information from nodes and AP(s) and can authenticate the nodes and AP(s) based on the identification information.

The network manager 431 further functions as an operational gateway or interface between the mesh network and the outside—and in particular as an interface for application(s) 121a/121b interfacing with the mesh network AP(s) and/or nodes. For this purpose, the application interface 437 may be executed on processor 433. The application interface 437 can receive data and information from the network (e.g., from AP(s), and/or from nodes via the AP(s)), format or process the data to put it in a format useable by the application(s) 121a/121b, and provide the raw or processed data to the application(s) 121a/121b. In this regard, the network manager 431 and application interface 437 can receive data and information from nodes, and can forward data received from such nodes to the application(s) 121a/121b. The application interface 437 can further receive data, information, or control information from the application(s) 121a/121b, format and process the data, information, or controls to put them in a format useable by the AP(s) and nodes, and provide the processed data, information, or controls to the AP(s) and nodes.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited, solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated o illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A mesh network system comprising:
a plurality of network nodes, each network node including a processor and a wireless transceiver configured for wireless communication with the other network nodes and access points of the mesh network system;
a network manager communicatively connected to the plurality of network nodes and configured to manage operation of a wireless mesh network including nodes of the plurality of network nodes; and
at least one network access point, each network access point including a processor, a wireless transceiver configured for wireless communication with the network nodes of the mesh network system, and a wired or wireless transceiver configured for communication with the network manager,
wherein the network manager and the plurality of network nodes are communicatively connected through the at least one network access point, and
wherein the at least one network access point is operative to synchronize its operation to an external clock, and to transmit timing information of the external clock to the network nodes of the mesh network system.

2. The mesh network system of claim 1, wherein the at least one network access point is operative to synchronize its operation to a GPS clock or a coordinated universal time (UTC) clock serving as the external clock.

3. The mesh network system of claim 1, wherein the at least one network access point comprises a plurality of network access points, and the wireless transceiver of each network access point of the plurality of network access points is further configured for wireless communication with other network access points of the plurality of network access points.

4. The mesh network system of claim 3, wherein multiple network access points of the plurality of network access points synchronize their operations to a UPS clock or a coordinated universal time (UTC) clock serving as the external clock.

5. The mesh network system of claim 3, wherein at least another network access point of the plurality of network access points is operative to synchronize its operation to the timing information transmitted by the at least one network access point of the mesh network system.

6. The mesh network system of claim 3, wherein the network manager controls each of the plurality of network access points to selectively synchronize its operation to one of the external clock and timing information of advertisement packets transmitted in the wireless mesh network.

7. The mesh network system of claim 3, wherein the network manager controls a first network access point of the plurality of network access points to transmit timing information of an internal clock of the first network access point to the network nodes of the mesh network system, and the network manager controls a second network access point of the plurality of network access points to synchronize its operation to the timing information received from the first network access point.

8. The mesh network system of claim 7, wherein the network manager further controls the second network access point of the plurality of network access points to transmit timing information of an internal clock of the second network access point to the network nodes of the mesh network system upon determining that the first network access point has failed.

9. The method network system of claim 3, wherein a first network access point of the plurality of network access points provides a communication link between the network manager and the plurality of network nodes, a second network access point of the plurality of network access points is synchronized to a same timing reference as the first network access point, and wherein the second network access point only provides a communication link between the network manager and the plurality of network nodes in response to determining that the first network access point has failed.

10. A mesh network system comprising:
a plurality of network nodes, each network node including a processor and a wireless transceiver configured for wireless communication with the other network nodes and access points of the mesh network system;
a network manager communicatively connected to the plurality of network nodes and configured to manage operation of a wireless mesh network including nodes of the plurality of network nodes; and
a plurality of network access points, each network access point including a processor, a wireless transceiver configured for wireless communication with the network nodes and other access points of the mesh network system, and a wired or wireless transceiver configured for communication with the network manager,
wherein each network access point of the plurality of network access points is operative to provide a communication link between the network manager and the plurality of network nodes,
wherein a first network access point of the plurality of network access points transmits timing information to the network nodes and other network access points of the mesh network, and
wherein a second network access point of the plurality of network access points synchronizes its operation to the timing information transmitted by the first network access point.

11. The mesh network system of claim 10, wherein the first network access point is operative to synchronize its operation to an external clock, and to transmit timing information of the external clock to the network nodes of the mesh network system.

12. The mesh network system of claim 11, wherein the first network access point is operative to synchronize its operation to a UPS clock or a coordinated universal time (UTC) clock serving as the external clock.

13. The mesh network system of claim 10, wherein the first network access point operates according to an internal clock of the first network access point, and transmits timing information of the internal clock to the network nodes and other network access points of the mesh network.

14. The mesh network system of claim 10, wherein the network manager controls the second network access point to transmit timing information to the network nodes and other network access points of the mesh network upon determining that the first network access point has failed.

15. The mesh network system of claim 10, wherein the first and second network access points concurrently operate to provide a communication link between the network manager and the plurality of network nodes.

16. A mesh network system comprising:
a plurality of network nodes, each network node including a processor and a wireless transceiver configured for wireless communication with the other network nodes and access points of the mesh network system to form a wireless mesh network, wherein the network nodes are configured to manage operation of the wireless mesh network; and
a plurality of network access points, each network access point including a processor, a wireless transceiver configured for wireless communication with the network nodes and other access points of the mesh network system, and a wired or wireless transceiver configured for communication across a wide area network (WAN),
wherein each network access point of the plurality of network access points is operative to provide a communication link between the WAN and the plurality of network nodes, and
wherein each network access point is operative to synchronize its operation to an external clock, and to transmit timing information of the external clock to the network nodes of the mesh network system.

17. The mesh network system of claim 16, wherein the plurality of network access points includes first and second network access points that are operative to provide communication links between the WAN and a respective one of first and second sub-sets of the plurality of network nodes, and
wherein network nodes of the first sub-set of network nodes can communicate with the network nodes of the second sub-set of network nodes through the WAN only.

18. The mesh network system of claim 16, wherein the plurality of network nodes are configured to manage operation of a wireless mesh network by establishing a communication schedule for the wireless mesh network.

19. The mesh network system of claim 16, wherein each network access point is operative to synchronize its operation to a GPS clock or a coordinated universal time (UTC) clock serving as the external clock.

20. The mesh network system of claim 16, wherein the plurality of network nodes share a common network identifier (ID) and network addresses that are compatible for use in the same network.
